(19) United States
(12) Patent Application Publication
(10) Pub. No.: US 2010/0152949 A1
(43) Pub. Date: Jun. 17, 2010

(54) VEHICLE EVENT RECORDING SYSTEM AND METHOD

(75) Inventors: Douglas A. Nunan, Kokomo, IN (US); Morgan D. Murphy, Kokomo, IN (US)

Correspondence Address: DELPHI TECHNOLOGIES, INC;LEGAL STAFF - M/C 483-400-402, 5725 DELPHI DRIVE, PO BOX 5052, TROY, MI, 48007, US

(73) Assignee: DELPHI TECHNOLOGIES, INC., Troy, MI (US)

(21) Appl. No.: 12/334,740

(22) Filed: Dec. 15, 2008

(51) Int. Cl. G06F 7/00

(52) U.S. Cl. 701/29

(57) ABSTRACT

A vehicle event recording system is provided which includes one or more GPS receivers for sensing position of a vehicle, and an event detector for detecting a vehicle event. The recording system includes memory for storing vehicle path data and an input for receiving site data at a location where the vehicle event is detected. The recording system further includes a processor for determining a vehicle path for a time period close in time to the vehicle event. The processor determines a correction vector based on site measurement data and further determines the corrected vehicle path based on the monitored vehicle path and the correction vector and generates an output.

### TECHNICAL FIELD

The present invention generally relates to vehicle monitoring systems and, more particularly, relates to an event recording system for recording and reconstructing events, such as accidents, related to a vehicle.

### BACKGROUND OF THE INVENTION

Vehicle event reconstruction is often employed to investigate a sequence of events that result in a vehicle accident. Conventional event reconstruction generally includes collecting and recording ground measurements and collecting other information that is stored on board the vehicle. Experts may then evaluate the collected information and attempt to determine the cause of an accident. By acquiring the sequence of events that leads to a vehicle leaving a roadway or otherwise involved in an accident, the information may be used to determine what occurred and may further be used to prevent future accidents.

It is desirable to provide for an event recording system that enables the acquisition of information during a vehicle event, such as an accident, so that enhanced vehicle event reconstruction may be realized.

### SUMMARY OF THE INVENTION

According to one aspect of the present invention, a vehicle event recording system is provided. The vehicle event recording system includes a position sensor for sensing position of a vehicle, an event detector for detecting a vehicle event, and memory for storing vehicle path data. The system also includes a controller for determining a vehicle path for a time period close in time to the vehicle event. The system further includes an output for outputting the determined vehicle path recorded during the time period.

According to another aspect of the present invention, a vehicle event recording system is provided which includes a position sensor for sensing the position of a vehicle, an event detector for detecting a vehicle event, and memory for storing vehicle path data. The system also includes an input for receiving site data at a location where the vehicle event is detected and a processor for determining a vehicle path for a time period close in time to the vehicle event, the processor determining a correction vector based on the site measurement data and further determining a corrected vehicle path based on the monitored vehicle path and the correction vector. The system further includes an output for outputting the corrected vehicle path.

According to a further aspect of the present invention, a method of monitoring and recording vehicle event data is provided. The method includes the steps of sensing the position of a vehicle, detecting a vehicle event, and storing vehicle path data in memory. The method also includes the steps of determining a vehicle path for a time period close in proximity to the vehicle event, and outputting the determined vehicle path recorded during the time period.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is a block diagram of a vehicle employing a vehicle event recording system, according to one embodiment;

FIG. 2 is a flow diagram illustrating a lane departure warning routine, according to one embodiment;

FIG. 3 is a flow diagram illustrating a correction routine for correcting the monitored vehicle path, according to one embodiment;

FIG. 4 is a schematic diagram illustrating one example of a sensed vehicle path corrected by a correction vector to provide a corrected vehicle path;

FIG. 5 is a schematic diagram illustrating one example of a vehicle travel path during a potential crash event; and

FIG. 6 is a schematic diagram illustrating one example of a vehicle travel path during another potential crash event.

### DESCRIPTION OF THE PREFERRED EMBODIMENT

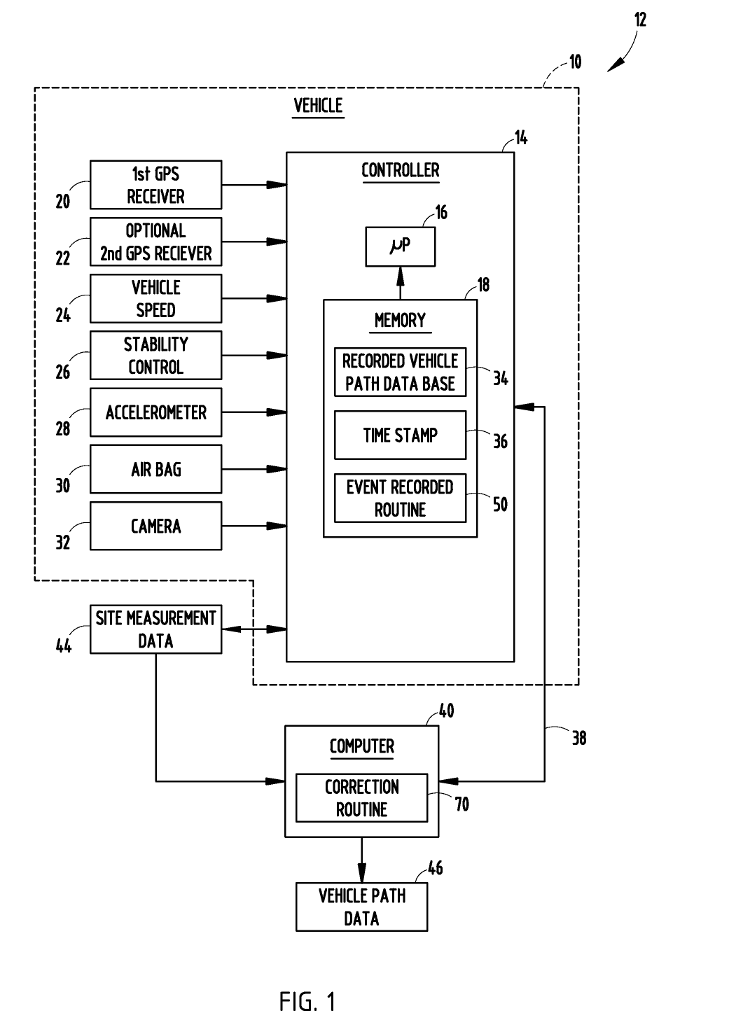

Referring now to FIG. 1, block 10 depicts a vehicle, such as a wheeled automotive vehicle, equipped with an event recording system 12, according to one embodiment. Vehicle 10 may include any of a number of vehicles configured to travel on a path, such as the lane of a roadway. In the disclosed embodiment, the vehicle 10 is a wheeled vehicle having wheels adapted to engage a roadway, and the vehicle 10 is steerable to maintain the vehicle within a desired lane of the roadway. It should be appreciated that the vehicle 10 may be steered by a driver of the vehicle 10 and that the vehicle 10 may be steered within a lane of a road and may depart from the lane, such as to maneuver into adjacent lanes, as should be evident to those skilled in the art.

The vehicle event recording system 12 is provided to monitor the position of the vehicle 10, to detect a vehicle event such as an accident, to process collected the site data, and to provide corrected vehicle position information relevant to the detected vehicle event. The vehicle event recording system 12 is shown including a controller 14 having various inputs 20-32 and 44 and providing an output 46. The controller 14 has control circuitry shown in the form of a microprocessor 16 and memory 18. It should be appreciated that the controller 14 may employ other analog and/or digital control or processing circuitry including an application specific integrated circuit (ASIC) or other known circuitry for processing the input data, executing the event recording logic, and outputting vehicle path data. It should further be appreciated that the controller 14 may be dedicated to vehicle event recording or may be a shared controller sharing functionality with other vehicle systems and/or devices.

The vehicle event recording system 12 is also shown including a computer 40 shown separate from the vehicle 10 in the disclosed embodiment. The computer 40 has a processor and may include a stand alone computer or may be integrated in another on board or off board system, such as with a diagnostics system. The computer 40 receives sites measurement data 44 and monitored position data, shown output from the controller 14. Additionally, the computer 40 has a correction routine 42 which processes the data from the controller 14 and the received site measurement data from input 44 and provides a correction vector that is applied to the GPS monitored vehicle path to provide a corrected vehicle path output. While the computer 40 is shown separate from controller 14, it should be appreciated that the controller 14 on board vehicle 10 may incorporate the correction routine therein, such that the corrected vehicle position information is determined on board the vehicle 10, according to another embodiment.

The memory 18 within controller 14 is shown including a recorded vehicle path database 34, a time stamp 36 and an event recorded routine 50. The memory 18 may include any known storage medium, such as random access memory (RAM), read-only memory (ROM), electronically erasable programmable read-only memory (EEPROM), flash memory and other memory devices. Stored within memory 18 is the recorded vehicle path data base 34 which may contain one or more recorded vehicle paths, particularly within a time period close in time to a detected vehicle event. The time stamp 36 provides a time indication as to the recorded vehicle position data. Also stored in memory is the event recorded routine 50 for recording the vehicle position data and time when the vehicle event is detected.

The event recording system 12 is shown having a number of devices inputting data to the controller 14. Included as inputs to controller 14 is a first global positioning system (GPS) receiver 20 and an optional second GPS receiver 22. The first and second GPS receivers 20 and 22 may each include a known GPS receiver for receiving global position system location data from GPS satellites as should be evident to those skilled in the art. The use of a single GPS receiver 20 provides longitude and latitude position coordinates at a single location where the GPS receiver 20 is located on board the vehicle 10. By employing an optional second GPS receiver 22 on board the vehicle 10 mounted at a known distance apart from the first GPS receiver 20, enhanced position accuracy may be achieved, in addition to determining vehicle yaw, direction and speed, which may be used for vehicle diagnostics and to simplify or replace the need for other added sensors within the system.

Current GPS receivers provide accurate position information. Some GPS receivers may provide accurate location information to within ±twelve (12) meters, while other GPS receivers may reliably provide better accuracy. In many systems, error may exist in the GPS receiver readings due to long-term error, such as that caused by weather, satellite position, time since the last position update, etc. Accordingly, the reading-to-reading error is generally very small, even if there is nominally a large offset. By obtaining site measurement data to achieve a final position reference, the GPS measured data can be corrected to provide for highly accurate location information to smooth the position data and thereby eliminate much of the GPS error.

Additionally, the vehicle event recording system 12 receives a vehicle speed signal 24 which may be an output from a vehicle speed sensor, or may be determined from the received GPS signals. A stability control signal 26 is also provided as an input to the vehicle event recording system 12 to provide an indication as to operation of the stability control system. Activation of the stability control system may be indicative of a vehicle event. Accordingly, by monitoring the stability control system, a vehicle event, such as an attempt to stabilize control of the vehicle 10, may be detected and used by the event recording system 12 to indicate an occurrence of a vehicle event. An accelerometer 28 provides an accelerometer signal as an input, such as may be used for air bag deployment on board the vehicle. The accelerometer 28 provides an acceleration signal that may also be used as an indication of a detected vehicle event for use by the vehicle event recording system 12. Similarly, an air bag 30 may provide an output signal that is used as an input to provide an indication of a vehicle event for use by the vehicle event recording system 12.

A camera 32 is also provided to supply video images input to the controller 14. The camera 32 may be located on board the vehicle 10 to provide images of the roadway or surrounding area of the vehicle. By capturing video images of the roadway near the vehicle 10, the vehicle event recording system 12 provide site information that may be useful for correcting the GPS location data to provide accurate, corrected location information. The video image(s) captured by the camera 32 at a time close in time to a detected vehicle event may be analyzed and used to generate site data which may serve to acquire a reference position.

Additionally, the vehicle event recording system 12 may receive site measurement data 44 shown as an input to both the controller 14 and computer 40. The site measurement data 44 may include vehicle location measurements taken at the site of the vehicle event. Site measurements may include measurements of vehicle tire tracks on the ground surface which may be compared to the GPS measured position to determine a correction vector. The correction vector may be applied to the GPS acquired location data to provide a corrected vehicle path. It should be appreciated that referenced location information may be acquired from the site measurement data 44 and/or from the video images provided by camera 32 and applied to the correction routine 42 which provides the corrected vehicle path data 46.

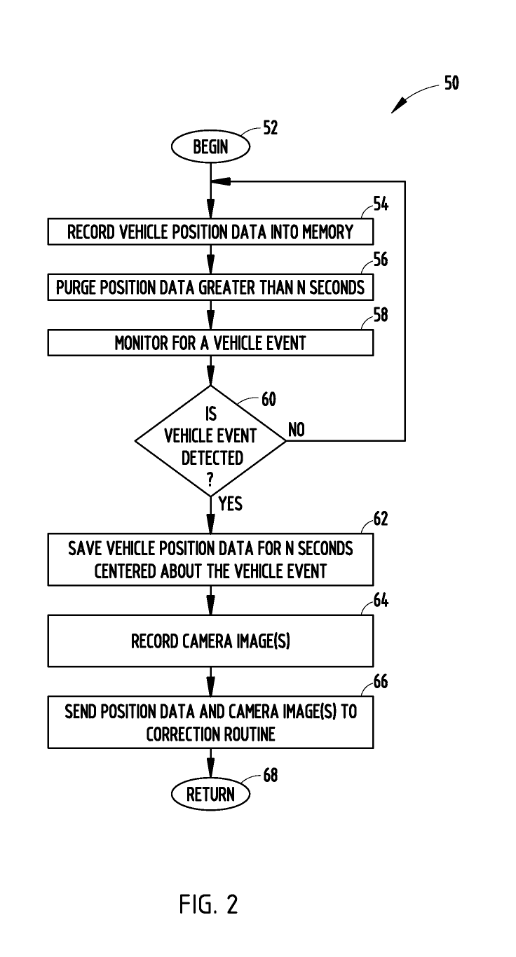

The event recorded routine 50 is illustrated in FIG. 2, according to one embodiment. Routine 50 begins at step 52 and proceeds to step 54 to record into memory vehicle position data acquired from the GPS receiver or GPS receiver(s). Next, in step 56, position data greater than a buffer of N seconds is purged from memory. It should be appreciated that the buffer may include a time window of approximately N=ten seconds, according to one example. Accordingly, only the most recent ten seconds of recorded GPS data are stored in memory. Memory may include a register that is overwritten during a ten second cycle.

Routine 50 monitors for a vehicle event in step 58. A vehicle event may include detection of a likely or potential accident which may be inferred by monitoring an air bag 30, accelerometer 28, stability control 26 or other indicator as to a vehicle event. In decision step 60, routine 50 determines if the vehicle event has been detected and, if not, returns to step 54. If a vehicle event has been detected, routine 50 proceeds to step 62 to save the current vehicle position data, which may be centered about the detected vehicle event. It should be appreciated that the N second window of saved vehicle position data may be otherwise allocated to contain more data at a time before the occurrence of the event, or may contain more data at a time after the occurrence of the event. It should further be appreciated that the N seconds of saved vehicle position data is recorded during a time period close in time to the vehicle event.

Additionally, in step 64, routine 50 records the camera image(s) acquired by the camera. It should be appreciated that the camera image(s) thereby also record at the time of a detected vehicle event. Routine 64 then proceeds to step 66 to send the position data and camera image(s) to the correction routine before returning at step 68.

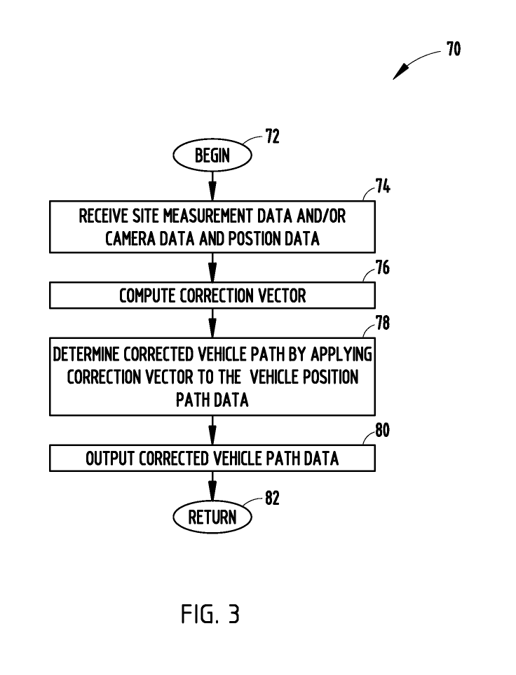

Referring to FIG. 3, the correction routine 70 is illustrated according to one embodiment. Correction routine 70 begins at step 72 and proceeds to receive the site measurement data and/or camera data and position data at step 74. In step 76, routine 70 computes a correction vector. The correction vector is indicative of the offset in the measured GPS data from the true vehicle location. This may be achieved by taking site measurement data and/or image(s) from the camera to get a reference location for comparison to the measured GPS location data. In step 78, routine 70 determines a corrected vehicle path by applying the correction vector to the vehicle position path data. Finally, step 70 outputs the corrected vehicle path data in step 80 before returning at step 82.

Referring to FIG. 4, one example of a vehicle trajectory is shown with measured GPS data shown by dotted line 90 and a correction vector 92 indicating the offset to a true vehicle path shown by solid line 94. It should be appreciated that the correction routine 70 may apply the correction vector 92 to the measured GPS location data 90 to determine the corrected vehicle location data information 94. This may be achieved by subtracting correction vector 92 from the measured GPS location data 90.

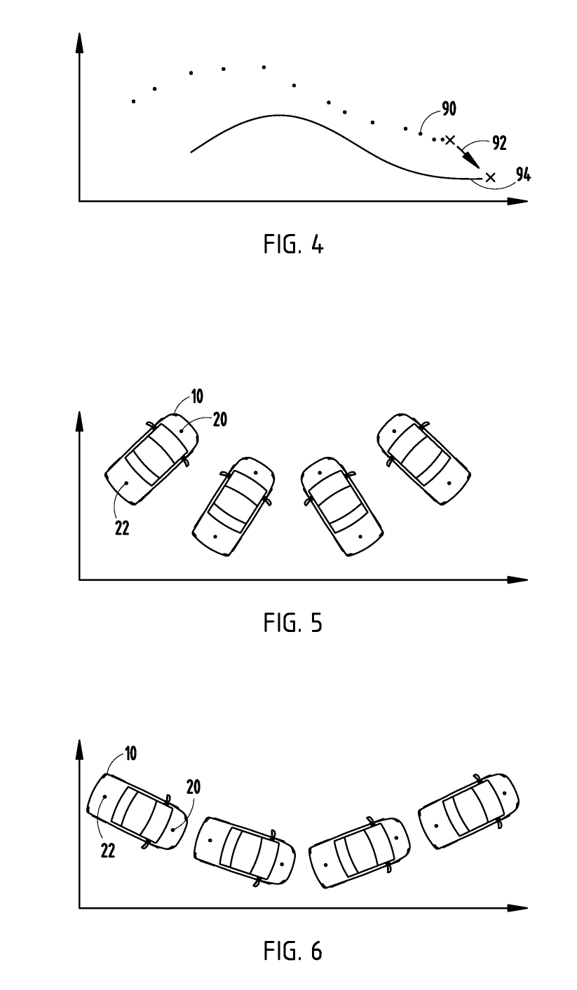

Referring to FIGS. 5 and 6, examples of vehicle path trajectories are illustrated for a vehicle 10 during a vehicle event, such as a vehicle spin out in FIG. 5 and a vehicle turn maneuver in FIG. 6. The vehicle 10 is shown in FIG. 5 having a vehicle yaw, such that the rear portion of the vehicle 10 rotates relative to the front. In this embodiment, two GPS receivers 20 and 22 are shown located on opposite ends of the vehicle, namely the front and rear end of the vehicle. By employing two GPS receivers 20 and 22 at known distances apart from each other, the vehicle yaw may further be determined from the GPS data. By monitoring the position data of the two GPS receivers 20 and 22 relative to each other, vehicle yaw can be acquired. The vehicle yaw may be useful in determining the travel path of the vehicle on the roadway.

Accordingly, the vehicle event recording system 12 of the present invention advantageously provides for event recording of a vehicle 10 which advantageously allows for reconstruction of the travel of the vehicle 10 prior to a collision or other accident. The vehicle event recording system 12 may provide for the determination of highly accurate vehicle path information by applying a correction vector to the measured GPS data which provides for a highly accurate reconstruction information.

It will be understood by those who practice the invention and those skilled in the art, that various modifications and improvements may be made to the invention without departing from the spirit of the disclosed concept. The scope of protection afforded is to be determined by the claims and by the breadth of interpretation allowed by law.

1. A vehicle event recording system comprising:
a position sensor for sensing position of a vehicle;
an event detector for detecting a vehicle event;
memory for storing vehicle path data;
a controller for determining a vehicle path for a time period close in time to the vehicle event; and
an output for outputting the determined vehicle path recorded during the time period.

2. The system as defined in claim 1 further comprising:
an input for receiving site measurement data and a processor for determining a correction vector based on the site measurement data and further determining a corrected vehicle path based on the monitored vehicle path and the correction vector.

3. The system as defined in claim 2, wherein the site measurement data comprises one or more video images captured with a camera.

4. The system as defined in claim 2, wherein the processor is remote from the vehicle.

5. The system as defined in claim 1, wherein the position sensor comprises a GPS receiver.

6. The system as defined in claim 1, wherein the position sensor comprises a first GPS receiver mounted on a vehicle and a second GPS receiver mounted on the vehicle.

7. The system as defined in claim 1, wherein the event detector comprises a crash sensor.

8. The system as defined in claim 7, wherein the crash sensor comprises an accelerometer.

9. The system as defined in claim 7, wherein the crash sensor comprises an air bag sensor.

10. The system as defined in claim 1, wherein the event detector comprises a stability control system.

11. The system as defined in claim 1 further comprising a time stamp for applying a time stamp to the received data.

12. A vehicle event recording system comprising:
a position sensor for sensing position of a vehicle;
an event detector for detecting a vehicle event;
memory for storing vehicle path data;
an input for receiving site data at a location where the vehicle event is detected;
a processor for determining a monitored vehicle path for a time period close in time to the vehicle event, said processor for determining a correction vector based on the site measurement data and further determining a corrected vehicle path based on the monitored vehicle path and the correction vector; and
an output for outputting the corrected vehicle path.

13. The system as defined in claim 12, wherein the site measurement data comprises one or more video images captured with a camera.

14. The system as defined in claim 12, wherein the processor is remote from the vehicle.

15. The system as defined in claim 12, wherein the position sensor comprises a GPS receiver.

16. The system as defined in claim 12, wherein the position sensor comprises a first GPS receiver mounted on a vehicle and a second GPS receiver mounted on the vehicle.

17. The system as defined in claim 12, wherein the event detector comprises a crash sensor.

18. The system as defined in claim 17, wherein the crash sensor comprises an accelerometer.

19. The system as defined in claim 17, wherein the crash sensor comprises an air bag sensor.

20. The system as defined in claim 12, wherein the event detector comprises a stability control system.

21. The system as defined in claim 12 further comprising a time stamp for applying a time stamp to the received data.

22. A method for monitoring and recording vehicle event data, said method comprising the steps of:
sensing the position of a vehicle;
detecting a vehicle event;
storing vehicle path data in memory;
determining a vehicle path for a time period close in proximity to the vehicle event; and
outputting the determined vehicle path recorded during the time period.

23. The method as defined in claim 22 further comprising the steps of:
receiving site data at a location where the event is detected;
determining a correction vector based on the site data; and
determining a corrected vehicle path based on the monitored vehicle path and the correction vector.

24. The method as defined in claim 23, wherein the site data comprises one or more video images captured with a camera.

25. The method as defined in claim 23, wherein the site data comprises site measurement data entered by a user.
